(19) United States
(12) Patent Application Publication
(10) Pub. No.: US 2014/0257834 A1
(43) Pub. Date: Sep. 11, 2014

(54) Method and System for Health Benefits Management

(71) Applicants: Jeffrey Johnson, Salt Lake City, UT (US); Rich Sprung, Salt Lake City, UT (US)

(72) Inventors: Jeffrey Johnson, Salt Lake City, UT (US); Rich Sprung, Salt Lake City, UT (US)

(21) Appl. No.: 14/192,938

(22) Filed: Feb. 28, 2014

Related U.S. Application Data
(60) Provisional application No. 61/772,621, filed on Mar. 5, 2013.

(51) Int. Cl. G06F 19/00

(52) U.S. Cl. CPC G06F 19/328
USPC 705/2

(57) ABSTRACT

A method of settling a health services transaction includes receiving input from a point-of-sale, including customer health benefits information. Payment is effected to a provider rendering the health services. A cost of the health services can then be recovered from one or more payment accounts, such as health savings accounts, checking and/or savings accounts, employer loan funds, and the like, in accordance with one or more payment recovery rules established by the customer.

### CROSS-REFERENCE TO RELATED APPLICATIONS

The present application claims the benefit of U.S. provisional application No. 61/772,621, filed 5 Mar. 2013, which is hereby incorporated by reference as though fully set forth herein.

### BACKGROUND

The instant invention relates to health benefits management. In particular, the instant invention relates to methods and systems that enable consumers to manage their health benefits in a more efficient and cost effective manner, enable employers to reduce the cost of managing their healthcare programs, and provide health services providers (e.g., pharmacies) with a more cost-effective way of collecting payments. More specifically, the present invention relates to management of benefits under High Deductible Health Plans (“HDHP”).

Currently, many health benefits programs for companies are managed by large insurance or processing entities, such as Health Maintenance Organizations (“HMOs”) and/or Pharmacy Benefits Managers (“PBMs”). For example, with respect to prescription drug programs, PBMs manage over 95% of all covered lives.

FIG. 1 depicts a representative PBM process according to the prior art. At the point-of-sale (e.g., the pharmacy 10), the consumer 12 presents various credentials 14. These credentials typically include an insurance card 14a, which includes information regarding the insurance plan covering the consumer, a prescription 14b, and a payment credential 14c (e.g., cash, credit card, debit card, check, health savings account card, flexible spending account card, etc.). The pharmacist inputs data from the various credentials 14 into a pharmacy management system 16, which submits a claim (arrow 17) through a switch 18 to one or more PBMs 20, each of which may be the prescription drug program interface for multiple insurance companies or self-insured companies 22.

Assuming coverage, the applicable PBM 20 returns an approval (arrow 23) to the pharmacy management system through switch 18. Approval 23 typically includes data 26 such as the average wholesale price for the prescription drug 26a, the contracted price (i.e., the price set by the PBM for the drug) 26b, the customer and insurance responsibility 26c and 26d, respectively, and the dispense fee paid by the PBM to the pharmacy 26e. The pharmacy collects the customer-responsible portion from the customer (arrow 27) and dispenses the prescription (arrow 29), but does not receive the insurance-responsible portion or dispense fee (from the PBM) until a later time (e.g., the next time payments are processed for the PBM and/or insurance company). Instead, the pharmacy management system keeps a record of its accounts receivable until such time as the dispense fee and the insurance-responsible payments are made.

As the ordinarily skilled artisan will appreciate, PBMs add complexity to health benefits management. For example, because PBMs often set medication pricing, pharmacies are left with little or no control over the cost of their drugs or the price they can charge to consumers for the same. This also makes it difficult, if not impossible, for consumers to comparison shop between and among local pharmacies or between pharmacy cash pricing or other cash discount programs. Moreover, the PBM claim and settlement process is lengthy and complex, resulting in uncertainty by providers as to when, or even if, they will be paid for the health services they rendered. In fact, this uncertainty can extend to the consumer, who may receive a bill for pharmacy or medical services weeks or even months later, in the event the PBM fails to pay the pharmacy.

HDHPs, on the other hand, typically have a lower premium and a higher deductible. Consumers of HDHPs (also referred to herein as “participants”) take the savings associated with the lower premium and fund a Health Savings Account (“HSA”). HSA funds can be used to pay out-of-pocket costs for health services on a tax-advantaged basis. HSA balances belong to the participant and are portable (that is, they go with the participant even if the participant changes jobs and/or health plans).

Once the participant reaches his or her deductible, the insurer will typically pay most, and often all, of the additional costs for the remainder of the plan year. Thus, HDHPs generally have a single payer, either the participant or the insurer, and the concept of a co-pay generally does not apply.

HDHPs further encourage participants to be savvy consumers and to seek the best service at the best price. Yet, employers (also referred to herein as “plan sponsors”), insurers, and health service providers often do not provide the tools participants need in order to make these educated decisions. Instead, these decisions are made by the insurers on behalf of their customers, the plan sponsors. Indeed, even though there is evidence that the participant can get a better price and/or better service by paying cash for health services, and even though this is encouraged by the plan sponsors, participants are typically without the tools necessary to accomplish these objectives (e.g., tools for comparison shopping or to apply cash purchases to their deductibles). Rather, participants are required to make direct contact with the health service providers (e.g., by telephone).

Of course, it is not unheard of for insurers, PBMs, cash discount card companies, and the like to provide applications (e.g., online or mobile applications) that allow, for example, a consumer to see the pricing the insurer, processor, or cash discount card company has negotiated with a given health services provider or group of health services providers. This, however, only allows the consumer to comparison shop amongst a predefined subset of health services providers (often referred to as a “provider network”), and fails to provide information about the cash price or other, more favorable options (e.g., using a cash discount card instead of insurance; using a health services provider outside the predefined subset). For example, a consumer that uses his or her insurance plan may pay $20 for a prescription, when the same pharmacy may offer the same drug for $4 as part of a cash prescription program.

In addition, cash card companies have arrangements with PBMs for pricing, not by setting up networks for pharmacies to set their own price. Some large chain pharmacies also offer cash card arrangements for their specific pharmacies that they may provide through their customer loyalty program.

### BRIEF SUMMARY

The present invention advantageously consolidates information from various pricing sources, making them all available to the participant for informed health services decision making.

The present invention also addresses the difficulty previously associated with the application of cash transactions to the participants' deductible. Currently, an HDHP participant is required to fill out forms and mail receipts to the insurance company. The present invention contemplates remote submission, for example by scanning a receipt or taking a picture of the receipt with a mobile device (e.g., a smartphone or tablet), and then sending the resultant image to a central site for processing and presentment to the insurance company. Alternatively, information can be gathered by a payment processing service and directly interfaced (e.g., through a file upload) to the insurance company's system of record for HDHP deductible management.

In another aspect, the invention consolidates financial information useful to a participant when making a purchase. This information can include, without limitation, HSA balances, demand deposit account (“DDA”) balances, medical loan balances, amounts already applied to the participant's deductible, and benefits paid by the insurer.

To further promote competition between health service providers, the invention also contemplates the establishment of a direct connection between participants and health services providers, allowing health services providers to set their own pricing outside of contract pricing with PBMs, insurance companies, cash discount cards, or other fixed-price entities. Advantageously, this will allow participants to comparison shop.

In the pharmacy context, the present invention stands in contrast to, and is an improvement over, the current insurance and processing company practice of establishing pricing for prescription drugs and refusing to allow pharmacies to participate in their networks without agreeing to the established pricing. Under current practice, pricing is typically set based on complex calculations and discounts off of standard pricing metrics that can change daily. Two of the most common metrics are Average Wholesale Price (“AWP”) and Maximum Allowable Cost (“MAC”). AWP is commonly used to determine brand drug pricing and is inflated over the actual cost of the drug to the pharmacy. Thus, pricing is generally set according to a formula of AWP less a certain percentage. MAC, on the other hand, is used to price generic drugs, and reflects the maximum price a health plan or insurance company is willing to pay for a specific drug. MAC can differ from insurer to insurer, from processor to processor, and/or between insurers and processors. This makes it difficult for pharmacies to determine how they will be reimbursed for dispensing a prescription. The present invention mitigates the current convoluted process by allowing pharmacies to set their own pricing and compete in the open market for business with other pharmacies, with insurers, with cash discount cards, and the like.

The invention also reduces the costs of processing payments by having a single payment at the point-of-sale or point-of-service (the terms “point-of-sale” and “point-of-service” are used interchangeably herein). The participant can pay the entire amount up front, including the insurance portion, or the amount can be paid to the health services provider in its entirety by a payment processing service, for example through an automated clearinghouse (“ACH”) transaction the following day. In either case, funding for the health services transaction can come from the participant's HSA, from the particpant's DDA (e.g., if there is not enough money in the HSA), by providing a loan to the participant to pay for the health services, or from the insurer (e.g., once the participant is over his or her deductible for the plan year). Regardless of how the payment will ultimately be covered, however, the health services provider receives one payment, either at the point-of-sale or via ACH, rather than the current approach of a partial payment (e.g., a co-pay) at the point-of-sale, with the balance of the payment from the insurer at some future date.

To this end, one aspect of the invention is a payment engine used by a payment processing service to settle health services transactions. Funds, with the permission of the consumer and according to payment recover rules, can automatically be deducted from an HSA, a DDA, or some other payment source (e.g., a loan fund or insurance fund).

An object of the present invention is to provide tools that make it easier for consumers to manage their health care costs.

Another object of the present invention is to provide methods to simplify and reduce risk in the payment process from the insurer to the health services provider.

Still another object of the present invention is to provide methods and systems that reduce overall health care costs by eliminating unnecessary steps in the process.

Disclosed herein is a method of settling a health services transaction, including: receiving input from a point-of-sale, the input comprising customer health benefits information; effecting payment for the health services to a provider rendering the health services; and recovering a cost of the health services from one or more payment accounts in accordance with one or more payment recovery rules established by the customer.

In certain aspects, a cost of the health services is recovered by debiting the cost of the health services from one or more of the customer's health savings account, the customer's bank account, an employer benefits fund in which the customer participates, and an employer loan fund to which the customer has access according to one or more payment recovery rules established by the customer.

Typically, the customer health benefits information includes customer identification information, customer payment credential information, and customer insurance information.

It is contemplated that the step of effecting payment for the health services can include paying the provider the cost of the health services less at least one fee, such as an interchange fee and/or a processing fee.

In general, the cost of the health services will be recovered after payment is effected therefor. Indeed, in certain embodiments of the invention, payment for the health services is effected entirely at the point-of-sale.

Also disclosed herein is a system for settling a health services transaction, including: a health benefits information processor configured to receive customer health benefits information as input; a provider payment processor configured to effect payment for health services to a provider rendering the health services; and a cost recovery processor configured to recover a cost of the health services from one or more payment accounts in accordance with one or more payment rules set by one or more of a customer and a health benefits provider.

According to another aspect, an electronic health benefits management tool includes: a payment account module; and a health services comparison shopping module. Optionally, the health benefits management tool can also include a health services research module.

The payment account module can include a rules engine operable to define one or more payment recovery rules. Similarly, the health services comparison shopping module can include an advertising engine operable to receive health services offers from one or more providers.

An advantage of the present invention is that it better enables consumers of health services to make health care decisions.

Another advantage of the present invention is that it better enables consumers of health services to manage the cost of such services.

Still another advantage of the present invention is that it simplifies and reduces risk in the payment process.

A further advantage of the present invention is that it reduces overall health care costs.

Yet another advantage of the present invention is that it improves medication compliance.

Yet a further advantage of the present invention is that it facilitates the benefits of competition in the health services marketplace.

The foregoing and other aspects, features, details, utilities, and advantages of the present invention will be apparent from reading the following description and claims, and from reviewing the accompanying drawings.

### BRIEF DESCRIPTION OF THE DRAWINGS

FIG. 1 illustrates a pharmacy transaction according to the prior art.

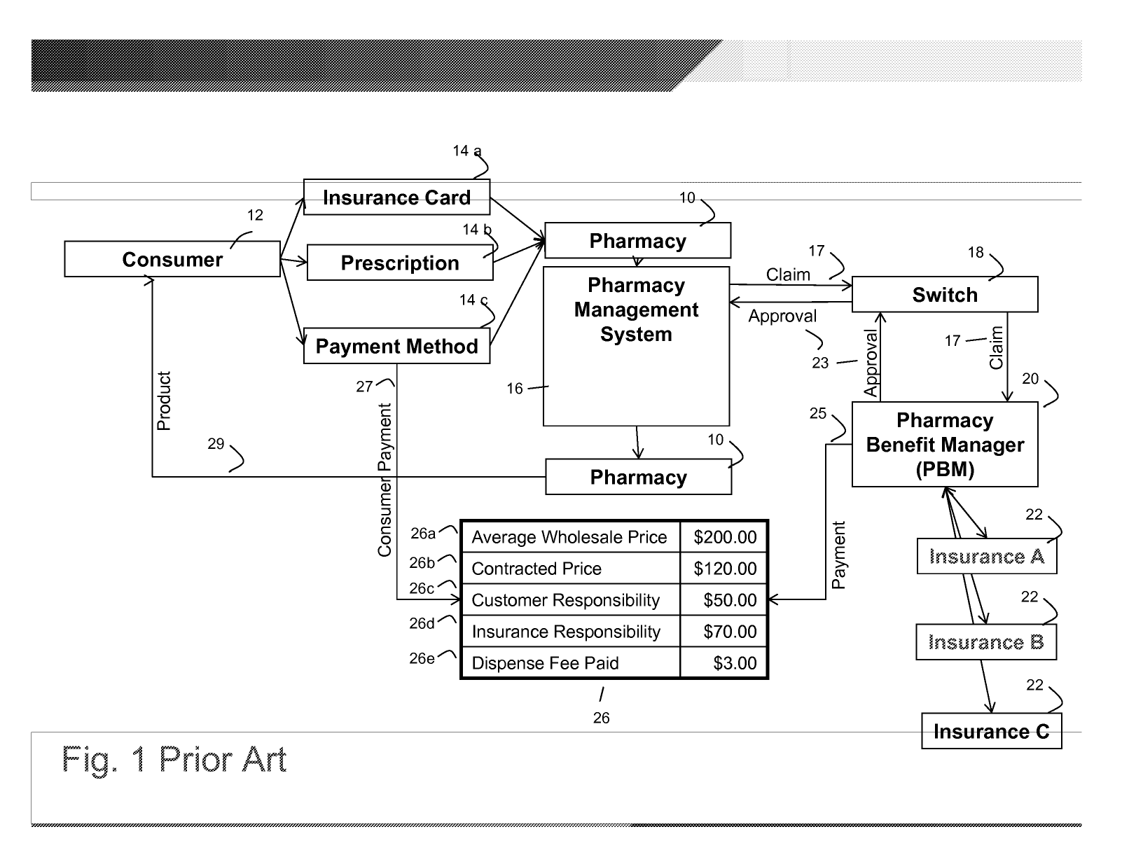

FIG. 2 illustrates a pharmacy transaction according to an embodiment of the present invention.

FIG. 3 illustrates a transaction settlement process according to an embodiment of the present invention.

FIG. 4 illustrates various mobile application tools that can be utilized to good advantage in connection with the present invention.

FIG. 5 is a schematic representation of a system for health benefits management according to the present invention.

FIG. 6 is illustrative of the types of information that can be provided to a consumer and/or a health services provider via mobile applications and/or network (e.g., Internet) portals in accordance with the teachings herein.

### DETAILED DESCRIPTION

For purposes of illustration, the present invention will be described in connection with methods and systems for the management of prescription drug benefits. It should be understood, however, that the principles disclosed herein can be practiced to good advantage in other contexts, including, for example, medical services (e.g., physician office visits), lab services, dental services, medical equipment, and the like. For purposes of this disclosure, the term “health services” will be used to refer generally to the foregoing. Thus, a “health services transaction” is a transaction whereby a consumer receives prescription drugs, medical equipment, medical treatment, dental treatment, lab services, etc. from a “health services provider” (e.g., a pharmacy, a physician, etc.).

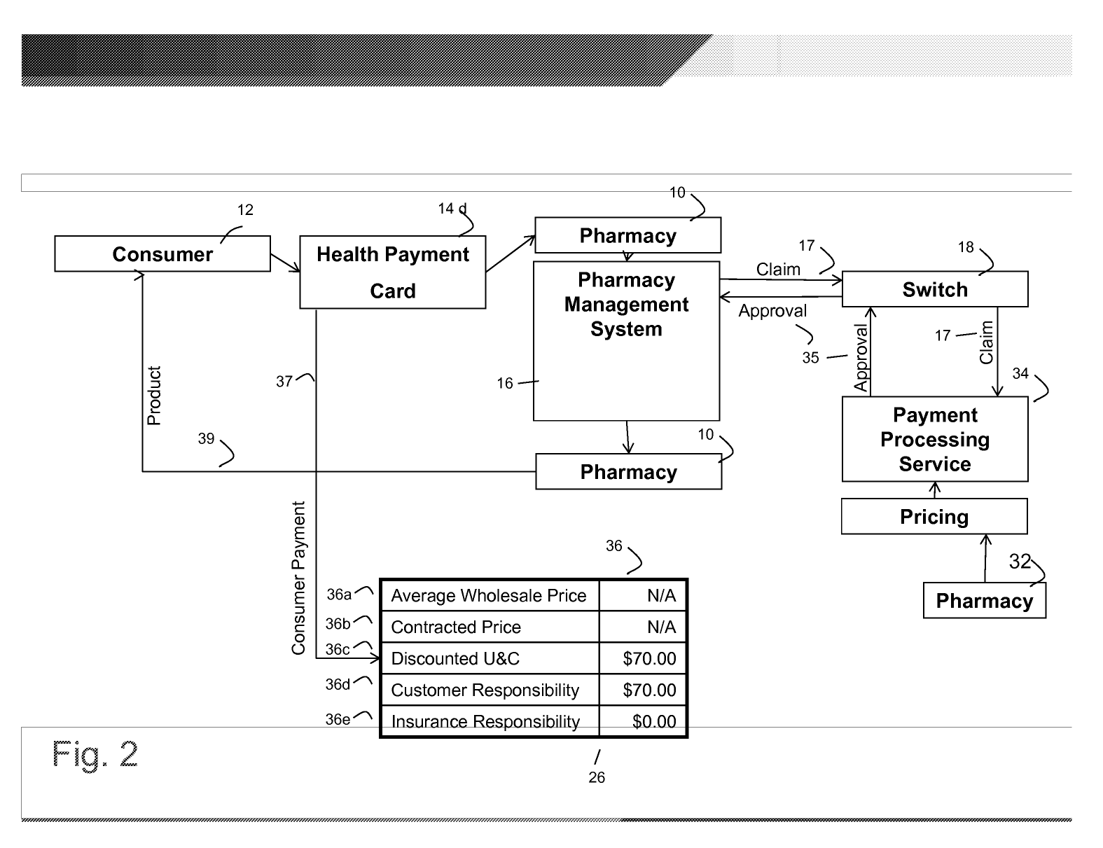

FIG. 2 depicts a method of settling a health services transaction, in this case a pharmacy transaction, according to the present invention. In general, in the embodiment of the invention depicted in FIG. 2, payment is made in full by consumer 12 at the point-of-sale, and the transaction is later settled in a back-office process (e.g., by payment processing service 34). Consumer 12 still presents at least one credential 14 at the point-of-sale (e.g., pharmacy 10). Advantageously, however, in certain embodiments of the present invention, consumer 12 need only present a single credential, health benefits card 14d, that provides all the information necessary for the pharmacist to provide services. That is, according to an aspect of the invention, a single card combines insurance information and payment information, and optionally also including prescription information.

Moreover, as discussed in further detail below, the payment information is linked not to a single payment account (e.g., a checking account, in the case of a debit card), but rather to several payment accounts (e.g., HSAs, DDAs, loan accounts, and the like). This greatly simplifies the point-of-sale process from both the consumer's perspective and the pharmacist's perspective. Of course, it is within the spirit and scope of the present invention to utilize separate credentials.

Pharmacy 10, in turn, submits a claim 17 through a switch 18 in a conventional manner. Rather than routing claim 17 to a PBM, however, the present invention routes claim 17 to a payment processing service 34. Payment processing service 34 returns a response 35, preferably through the same switch 18, though a different switch could be employed without departing from the teachings herein. The response 35 includes various data 36, in a manner similar to extant processes. Note, however, that average wholesale price 36a and a contracted price 36b are not required in accordance with the present teachings because the pricing has been set by pharmacy 10. This pricing can be set based at least in part upon the specific needs of pharmacy 10, including, for example, discounted usual and customary fees 36c, or some other method such as a fixed dollar amount or a price-matching algorithm.

Data can also include a customer-responsible amount 36d. In the case where consumer 12 is paying using health benefits card 14d, the customer responsible amount will be 100% of the amount owed to pharmacy 10.

The data can also include an insurance-responsible amount 36e. Where settlement is handled by payment processing service 34, the insurance-responsible amount will be 100% of the amount owed to pharmacy 10.

Where consumer 12 is paying using health benefits card 14d, pharmacy 10 then collects the customer-responsible amount (arrow 37) and delivers the medicine (arrow 39).

One advantage of the present invention is that it can eliminate contract pricing, thereby allowing the pharmacy 10 to set its own price for drugs, as reflected in FIG. 2 (e.g., the contracted price field 36b is set to N/A, with the price, including any discounts, reflected in field 36c).

Another advantage of the present invention is that, in embodiments where consumer 12 is paying using health benefits card 14d, the insurance-responsible amount (shown in field 36e) will generally be $0, with the full cost of the prescription to be borne by consumer 12, subject to after-the-fact settlement with insurance amounts by payment processing service 34.

Thus, in accordance with the present invention, there is minimal delay in and uncertainty associated with payment to pharmacy 10. In other words, pharmacy 10 receives 100% payment for drugs dispensed at the point- and time-of-sale in a single payment, in a manner similar to other retail transactions, regardless of how consumer 12 or its insurance plan ultimately funds the purchase.

Alternatively, the consumer's insurance plan can pay in full (i.e., 100% insurance-responsible) at the point- and time-of-sale in a single payment. Although somewhat different than other retail transactions, risk and uncertainty for pharmacy 10 is still minimized.

The details of how consumer 12 or its insurance plan ultimately funds the purchase, whether the point-of-sale transaction is entirely customer-responsible, entirely insurance-responsible, or some mix (that is, final settlement of the health services transaction) occur within payment processing service 34, as discussed in further detail below, and, representing a significant advantage over the prior art, are transparent to and of no consequence to pharmacy 10.

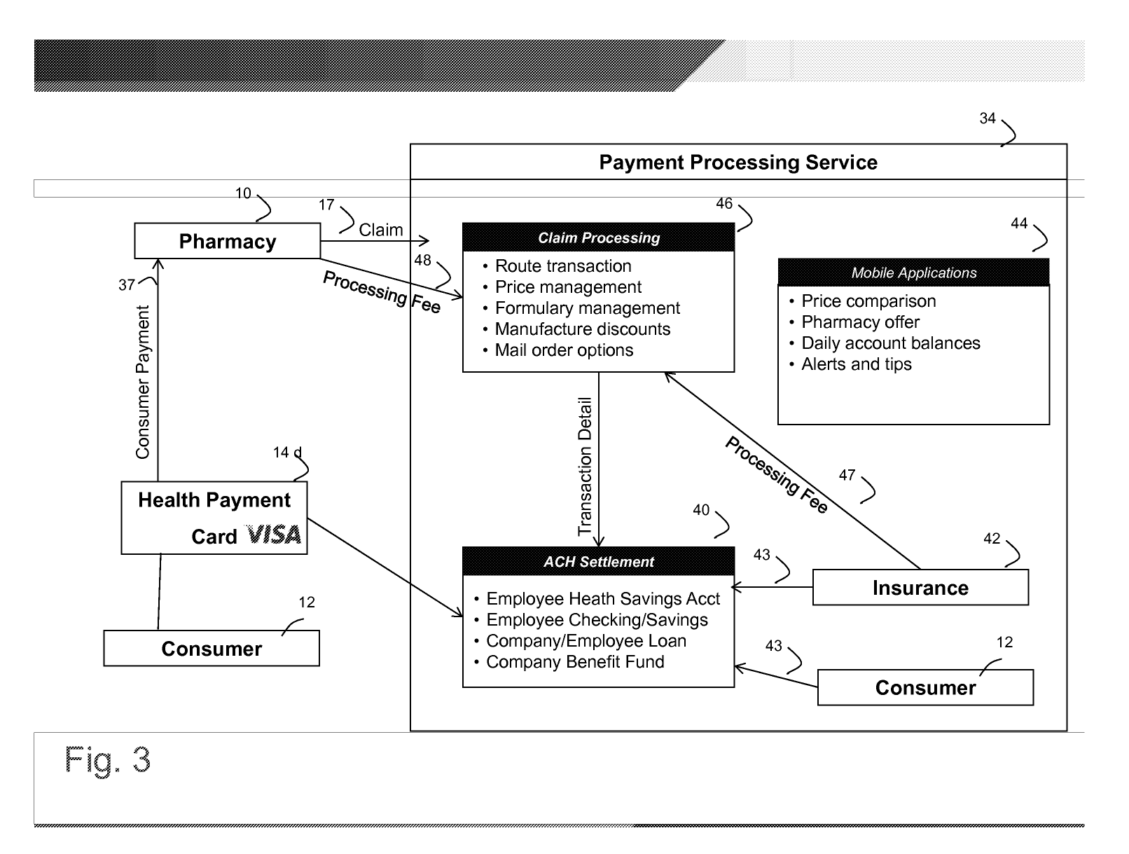

FIG. 3 illustrates one method by which payment processing service 34 can settle a health services transaction in accordance with the present teachings. According to the embodiment depicted in FIG. 3, health benefits card 14d operates, from the perspective of pharmacy 10, as a traditional credit card (e.g., a VISA card), with a credit limit set sufficiently high to ensure that both consumer 12 and pharmacy 10 can be assured of payment at the point-of-sale (e.g., $5,000).

Payment processing service 34 then settles the transaction to recover the customer-responsible portion (e.g., $40.00, in the case of FIG. 2) from one or more payment accounts 40. Exemplary payment accounts 40 include employee health savings accounts (“HSAs”), employee bank accounts (e.g., checking accounts, money market accounts, savings accounts, and the like), company loan funds to which consumer 12 has access, and company benefit funds to which consumer 12 has access. Of course, it is also within the spirit and scope of the present invention to settle the transaction with funds from other payment accounts (e.g., flexible spending accounts, insurance company funds, and the like). Thus, both the insurance company 42 and the employee (i.e., consumer 12) make contributions (arrows 43) to the payment accounts.

Typically, consumer 12 will also define one or more payment recovery rules, for example using a web portal and/or a mobile application 44, that dictate how payment processing service 34 recovers the cost of the health services (e.g., the $40.00 payment in the case of FIG. 2) from the payment accounts. For example, consumer 12 may specify that payments should come first from his or her HSA, then from his or her checking account, then from a company benefit fund to which he or she has access, and finally from a company loan fund to which he or she has access. As another example, consumer 12 may specify that payments should come first from his or her HSA, then funds should be transferred from his or her checking account into the HSA up to a specified amount, then from a company loan fund to which he or she has access. In another aspect, where pharmacy 10 was paid in full by the insurance company (i.e., 100% insurance-responsible at the point-of-sale), ACH settlement 40 can be made as if pharmacy 10 was paid using health benefits card 14d. Other permutations are also contemplated. These payment rules are used by payment processing service 34 to process the claim 46.

Payment processing service 34 can also charge a processing fee 47 as part of the transaction settlement. This processing fee represents revenue to payment processing service 34. In addition, the use of health benefits card 14d can generate interchange for an issuing bank.

Pharmacy 10 can also pay a processing fee 48 to payment processing service 34, for example if pharmacy 10 is paid in full by payment processing service 34 on behalf of an insurance company, thereby saving interchange fees otherwise payable if consumer 12 used a credit or debit card at the point-of-sale.

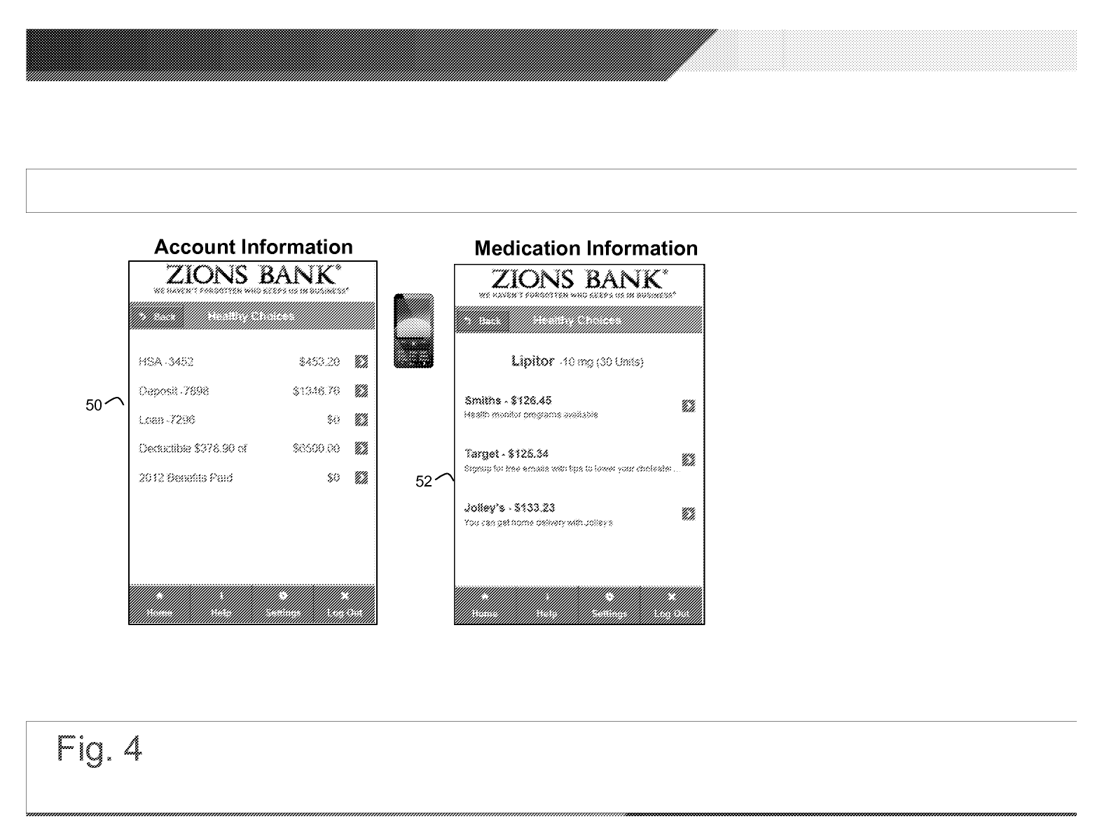

As described above, consumer 12 may be provided with one or more mobile applications 44, for example as an interface through which to define the payment recovery rules. Mobile applications 44 offer additional advantages. FIG. 4 depicts two representative mobile application 44 screen shots 50, 52.

Screen shot 50 depicts an account information screen that provides balances for various payment accounts, for example as part of a payment accounts module. The account information screen can also provide information about the consumer's deductible and the amount of insurance benefits the consumer has received. Additional detail can be provided by tapping the detail arrows on any line item.

Screen shot 52 depicts a medication information screen that provides information regarding a particular prescription drug (e.g., Lipitor), for example as part of a health services comparison shopping module. The medication information screen can provide information regarding nearby pharmacies and their respective prices for the selected drug, thereby facilitating comparison shopping. Additional detail can be provided by tapping the detail arrows on any line item. The comparison shopping module can also provide information regarding offers made by a pharmacy to the consumer, for example via an advertising engine.

One surprising advantage of the comparison shopping tool is improved health care cost management. For example, consumers participating in high deductible health plans (“HDHPs”) bear a greater degree of responsibility for healthcare cost management than do consumers participating in HMOs, because they bear a greater proportion of the cost of their healthcare than do consumers participating in HMOs. The information provided by the comparison shopping tool described herein enables HDHP participants to better manage their healthcare costs.

An additional and surprising advantage of the comparison shopping tool is improved patient compliance and medication adherence. Because HDHP participants bear a greater proportion of the cost of their healthcare, HDHP participants may attempt to save money by not complying with physician instructions (e.g., by not filling prescriptions), particularly with respect to preventive measures. This, of course, can lead to greater overall health care costs, for example when the consumer suffers an acute episode (e.g., a heart attack) that could have been prevented by taking the prescribed medication (e.g., a statin, such as Lipitor). The comparison shopping module described herein provides alternative, and preferable, methods of managing health care costs. Indeed, the reintroduction of comparison shopping can reduce health care costs through operation of a free-market for prescription drugs (e.g., competitive pricing and special offers).

Additional modules, such as medical reference modules, social media modules, explicit crowdsourcing modules, and the like, can also be incorporated into mobile application 44.

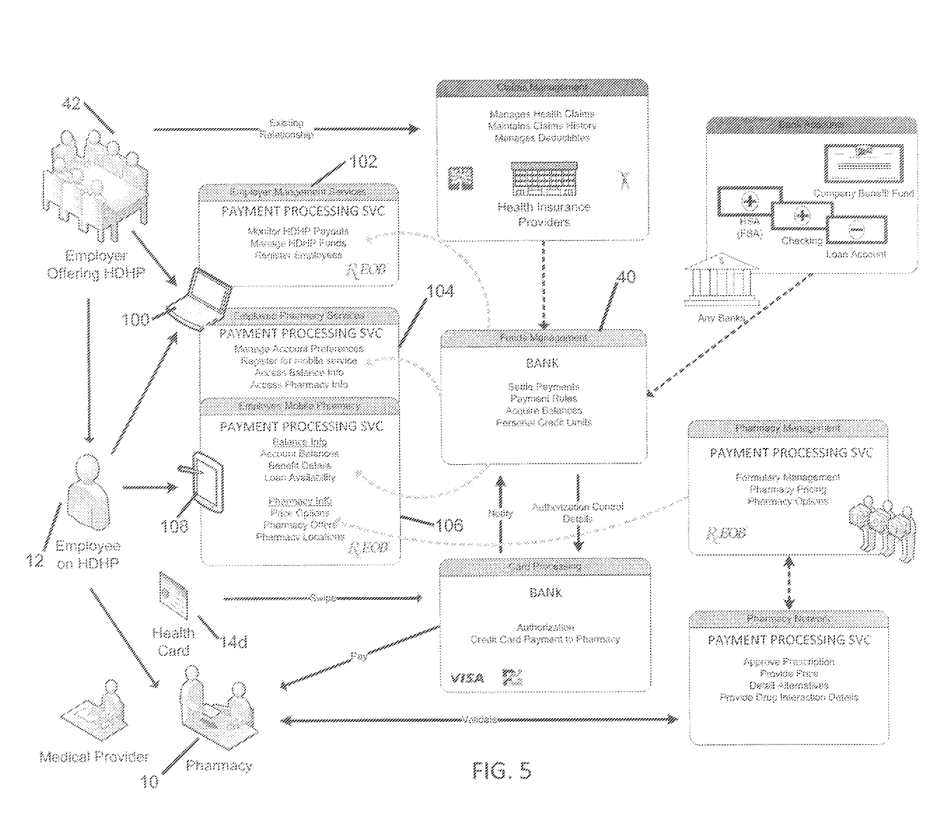

FIG. 5 is a schematic representation of a system for health benefits management according to the teachings herein. FIG. 5 depicts a portal, preferably accessible via an Internet-connected computing device 100, for both employers 42 and consumers 12 to access various functions provided by payment processing service 34. These functions include, without limitation, employer management services 102 (e.g., monitor HDHP payouts, manage HDHP funds, and register/enroll/de-enroll/update employee records) and employee services 104 (e.g., manage account preferences/payment rules, register for mobile service, access balances, access pharmacy information). Employee 12 can also access functions 106, as described above in connection with mobile applications 44, through a mobile device 108.

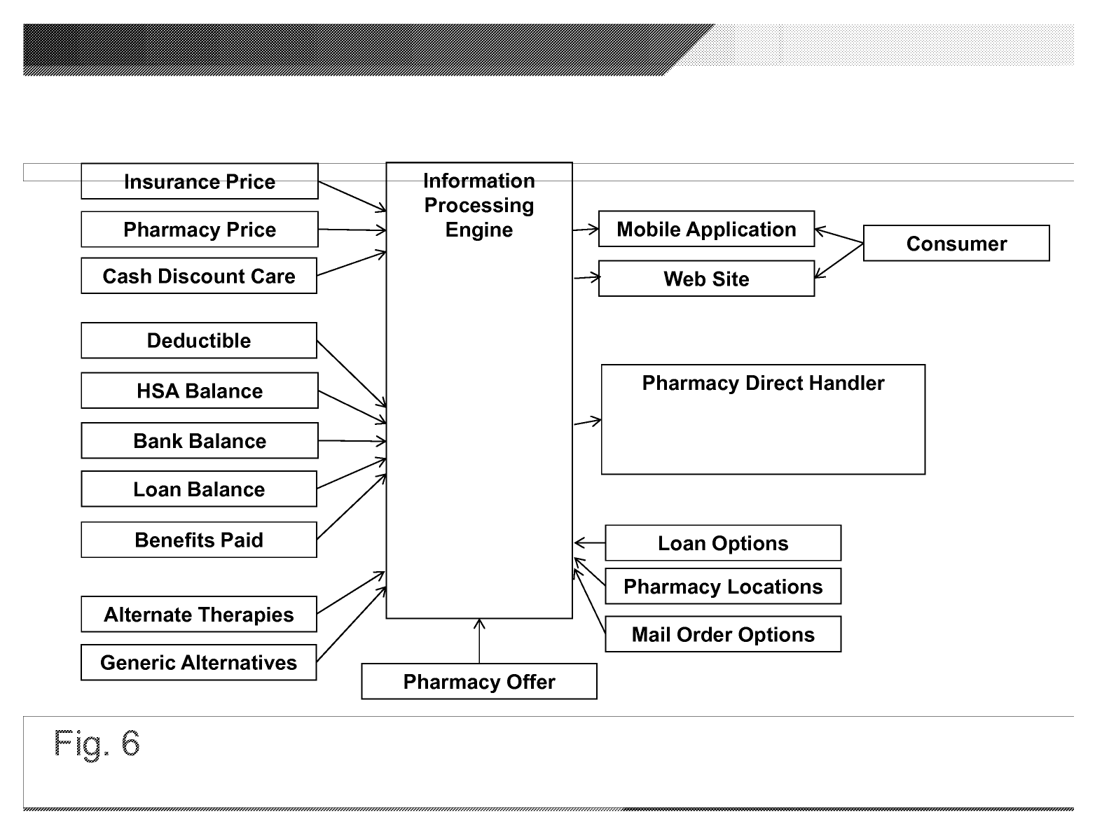

FIG. 6 illustrates various types of information that can be made accessible to consumers and/or health services providers in accordance with the present invention. This information includes, without limitation, pricing (e.g., insurance price, pharmacy price, cash discount price), balance information (e.g., remaining deductible, HSA balances, DDA balances, loan balances, benefits paid), health information (e.g., alternative therapies, generic alternatives), marketing offers information (e.g., pharmacy offers, coupons), and other information (e.g., loan options, pharmacy locations, mail order options). This information will preferably be accessible both via one or more mobile applications, as well as via a network portal (e.g., a website).

Although several embodiments of this invention have been described above with a certain degree of particularity, those skilled in the art could make numerous alterations to the disclosed embodiments without departing from the spirit or scope of this invention.

For example, although the term “point-of-sale” is used herein specifically in specific reference to a pharmacy, the ordinarily skilled artisan will appreciate that it is equally applicable to other places where health services are rendered (e.g., at a doctor's office, at a medical lab, at a dentist's office, and the like).

As another example, although the single credential disclosed herein is described as a “card,” (e.g., health payment card 14d), the credential is not so limited. Indeed, it is contemplated that, rather than a physical card, the consumer's credential could be presented via smartphone or other electronic device, for example in a manner similar to the presentation of electronic airline boarding passes.

It is intended that all matter contained in the above description or shown in the accompanying drawings shall be interpreted as illustrative only and not limiting. Changes in detail or structure may be made without departing from the spirit of the invention as defined in the appended claims.

What is claimed is:

1. A method of settling a health services transaction, the method comprising:
receiving input from a point-of-sale, the input comprising customer health benefits information;
effecting payment for the health services to a provider rendering the health services; and
recovering a cost of the health services from one or more payment accounts in accordance with one or more payment recovery rules established by the customer.

2. The method according to claim 1, wherein the step of recovering a cost of the health services comprises debiting the cost of the health services from one or more of the customer's health savings account, the customer's bank account, an employer benefits fund in which the customer participates, and an employer loan fund to which the customer has access according to one or more payment recovery rules established by the customer.

3. The method according to claim 1, wherein the customer health benefits information comprises customer identification information, customer payment credential information, and customer insurance information.

4. The method according to claim 1, wherein the step of effecting payment for the health services comprises paying the provider the cost of the health services less at least one fee.

5. The method according to claim 4, wherein the at least one fee is selected from the group consisting of interchange fees and processing fees.

6. The method according to claim 1, wherein the step of recovering a cost of the health services occurs after the step of effecting payment for the health services.

7. The method according to claim 1, wherein the step of effecting payment for the health services occurs entirely at the point-of-sale.

8. A system for settling a health services transaction, comprising:
a health benefits information processor configured to receive customer health benefits information as input;
a provider payment processor configured to effect payment for health services to a provider rendering the health services; and
a cost recovery processor configured to recover a cost of the health services from one or more payment accounts in accordance with one or more payment rules set by one or more of a customer and a health benefits provider.

9. An electronic health benefits management tool, comprising:
a payment account module; and
a health services comparison shopping module.

10. The health benefits management tool according to claim 8, further comprising a health services research module.

11. The health benefits management tool according to claim 8, wherein the payment account module includes a rules engine operable to define one or more payment recovery rules.

12. The health benefits management tool according to claim 8, wherein the health services comparison shopping module includes an advertising engine operable to receive health services offers from one or more providers.
